(19) United States
(12) Patent Application Publication
(10) Pub. No.: US 2001/0054025 A1
(43) Pub. Date: Dec. 20, 2001

(54) Method of securely delivering a package

(76) Inventors: William M. Adams II, San Francisco, CA (US); Manuel J. Paikeday, San Francisco, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/811,124

(22) Filed: Mar. 16, 2001

Related U.S. Application Data
(60) Provisional application No. 60/228,255, filed on Aug. 25, 2000.
(60) Provisional application No. 60/212,703, filed on Jun. 19, 2000.

(51) Int. Cl. H04L 9/00

(52) U.S. Cl. 705/50; 713/200

(57) ABSTRACT

A method is provided for delivering a package securely. An address is located on a delivery package. The package is handed to a delivery entity, which utilizes the address on the package to seek and find the specific physical location identified by the address. A delivery identifier is provided to a processor of a cryptographic authority computer. A delivery identifier identifies a specific enclosure at the specific physical location and differs from delivery enclosures at other locations. A request time is provided to the processor of the cryptographic authority computer. The processor of the cryptographic authority computer generates a cryptographic key utilizing the delivery identifier and the request time. The cryptographic key is provided to the delivery entity for entry and decryption by a computer at the location, to allow for unlocking of a lock on an enclosure where the delivery package can be located.

### CROSS-REFERENCE TO RELATED APPLICATIONS

Priority is claimed from Provisional Application No. 60/212,703, filed on Jun. 19, 2000.

### BACKGROUND OF THE INVENTION

1). Field of the Invention

This invention relates to a method of securely delivering a package.

2). Discussion of Related Art

Networks, in particular the Internet, are frequently used for ordering packages “online”. A client at a client computer utilizes the client computer to log onto an etailer computer. The client then browses through, or searches a database of articles offered for sale by the etailer. The client can select a specific article to be ordered, whereupon an order page with details of the article and its price is displayed on a display of the client computer. The client can enter order details on the order page including credit card or other payment details, and a delivery address, whereafter the client clicks on an order button. The order details are transmitted back to the etailer computer when the order button is clicked.

The etailer then selects a specific delivery package corresponding to the ordered article from many delivery packages, usually held in stock, and locates a label on the delivery package indicating the address provided by the client. The delivery package is then provided to a delivery entity, such a courier service, which delivers the package to a location identified by the address.

When a delivery person employed by the delivery service reaches premises at the location where the package is to be delivered, the delivery person usually knocks on a door or rings a doorbell of the premises. A person at the premises may open the door and receive the delivery package directly from the delivery person.

A frequent occurrence is that there is no person at the delivery location when the package is delivered. The delivery person may then leave the package at the door. A package left in such a matter is subject to theft or can be damaged by environmental conditions. In other cases, a delivery company's policy may dictate that a re-delivery attempt should be made rather than leaving a package unattended at the location of the attempted delivery. This results in inconvenience for the intended recipient of the package who must wait additional time for delivery to take place or make a special trip to the delivery depot to pick up the package in person.

### SUMMARY OF THE INVENTION

A method is provided for delivering a package securely. An address is associated with a delivery package. In many cases, the address will be located on the package. The address identifies a specific physical location that differs from addresses of other locations. The package is handed to a delivery entity. The delivery entity utilizes the address associated with the package to seek and find the specific physical location identified by the address. The delivery identifier is provided to a processor of a cryptographic authority computer. A delivery identifier identifies a specific enclosure at the specific physical location and differs from delivery identifiers of delivery enclosures at other locations. A request time is provided to the processor of the cryptographic authority computer. The processor of the cryptographic authority computer generates a cryptographic key utilizing the delivery identifier and the request time. The cryptographic key is provided to the delivery entity. The delivery entity enters the cryptographic key into a processor of a delivery computer. The delivery computer decrypts the cryptographic key and causes for a lock on the delivery enclosure to be unlocked if the delivery identifier matches a proof identifier located in the delivery computer and a difference in time between a proof time, from a clock providing the proof time to the processor of the delivery computer, and the request time is less than a selected maximum. Unlocking of the lock allows the delivery entity to open a closure member of the enclosure to gain access to an internal volume of the enclosure. The delivery entity then locates the delivery package in the internal volume.

### BRIEF DESCRIPTION OF THE DRAWINGS

The invention is further described by way of example with reference to the accompanying drawings wherein:

FIG. 1 illustrates a system used for a method of delivering a package according to an embodiment of the invention;

FIG. 2 is an interaction diagram illustrating how the system can be used for securely delivering a package;

FIG. 3 is a block diagram illustrating one client computer, also shown in FIG. 1, further including a data forwarding application;

FIG. 4 is an interaction diagram illustrating another method of using the system to deliver a package, wherein a client computer is bypassed;

FIG. 5 is an interaction diagram of how the system can be used wherein a cryptographic key is directly transmitted from a processor of an encryption authority computer to a mobile computer of a delivery entity, instead of transmitting the cryptographic key first to an etailer computer;

FIG. 6 is an interaction diagram similar to FIG. 5 but wherein a secret code known to a delivery person is used instead of a secret code known to an etailer; and

FIG. 7 is a block diagram of one computer used in the system.

### DETAILED DESCRIPTION OF THE INVENTION

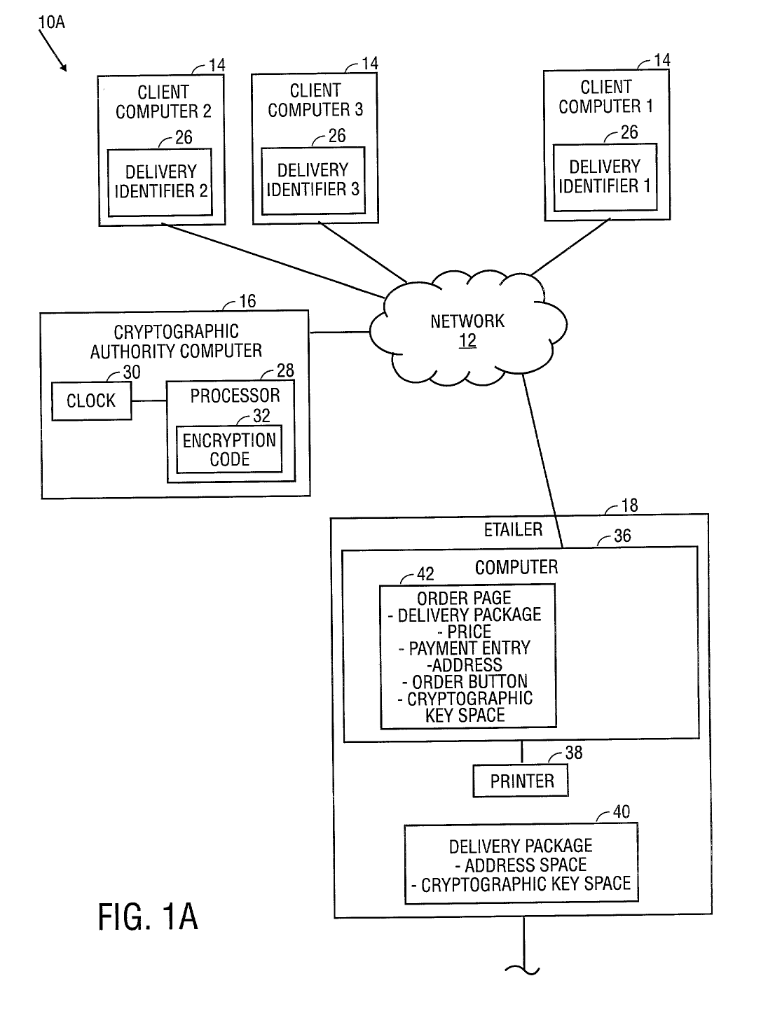

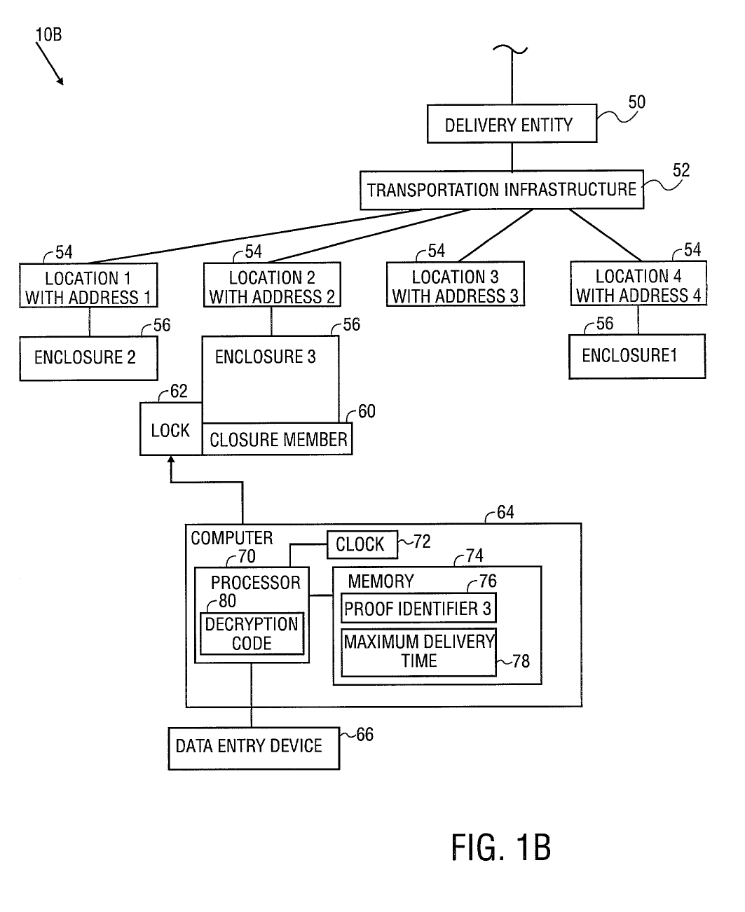

FIG. 1 illustrates a system that can be used for carrying out a method of delivering a package, according to the invention. FIG. 1A illustrates a subsystem 10A of the system and FIG. 1B illustrates another subsystem 10B of the system.

Referring firstly to FIG. 1A, the subsystem 10A includes a network 12 in the form of the Internet network, a plurality of client computers 14, each being connected to the network 12, a cryptographic authority computer 16 connected to the network 12, and an etailer 18.

Each client computer 14 has a specific delivery identifier 26 stored in memory therein. The delivery identifiers 26 differ from one another. A specific client computer 14 can thus be identified by identifying the specific delivery identifier 26.

The cryptographic authority computer 16 includes a processor 28 and, connected to the processor 285, a clock 30. Encryption code 32 is stored in the processor 28.

The etailer 18 is an etailer such as Amazon.com, etc. The etailer 18 has in its possession an etailer computer 36, a printer 38, and a plurality of delivery packages 40 (one of which is shown). The computer 36 is also connected to the network 12. An order page 32 is stored in a processor of the computer 36. The order page includes information regarding a delivery package, the price of the delivery package, a space for entry of payment and an address, a space for entry of a cryptographic key, and an order button. The printer 38 is connected to the computer. The delivery package 40 may or may not be wrapped or boxed, but generally includes visible address space and cryptographic key space thereon.

Referring now to FIG. 1B, the subsystem 10B includes a delivery entity 50, a transportation infrastructure 52, a plurality of different physical locations 54, and a respective enclosure 56 at selected ones of the locations 54. The subsystem 10B further includes a respective closure member 60, a lock 62, a computer 64, and a data entry device 66 at each one of the enclosures 56.

The delivery entity 50 is typically a courier service having access to the transportation infrastructure 52. The transportation infrastructure 52 may include personnel, vehicles, and transportation modes such as roads and rail that are at the disposal of the delivery entity 50. The delivery entity 50 may use the transportation infrastructure 52 to obtain the delivery package 40 from the etailer 18 and transport the delivery package 40 to a selected one of the locations 54.

Each location 54 may be a residential location or a business location having a respective address, the addresses being different from one another. Each enclosure 56 has an internal volume that is sufficiently large for the delivery package 40 to be located therein.

The closure member 60 may be a door of the enclosure 56. The closure member 60 can be moved between two positions. In a closed position the closure member 60 closes an opening into the enclosure 56 so that the delivery package 40 cannot be inserted into the enclosure 56 or a delivery package cannot be removed from the enclosure 56. In an open position, the closure member 60 is moved into a position wherein a delivery package can be inserted into the enclosure 56.

The lock 62 is secured to the enclosure 56 and has a latch that catches on the closure member 60. Engagement of the lock 62 secures the closure member 60 in its closed position. Disengagement of the lock 62 allows the closure member 60 to be moved out of the closed position so that access can be gained into the enclosure 56. Movement of the closure member 60 back into its closed position automatically engages the lock 62 with the closure member 60 so that the closure member 60 is again engaged in its closed position.

The computer 64 controls the lock 62 such that the lock 62 can be disengaged by the computer 64, thereby allowing for the closure member 60 to be moved out of its closed position. The computer 64 includes a processor 70, a clock 72, and memory 74. A proof identifier 76 is stored in the memory 74. A maximum delivery time 78 is also stored in the memory 74. The maximum delivery time 78 is a fixed value which can only be changed by reprogramming the computer 64 such that the maximum delivery time 78 is altered. The clock 72 and the memory 74 are connected to the processor 70. A decryption code 80 is stored in the processor 70.

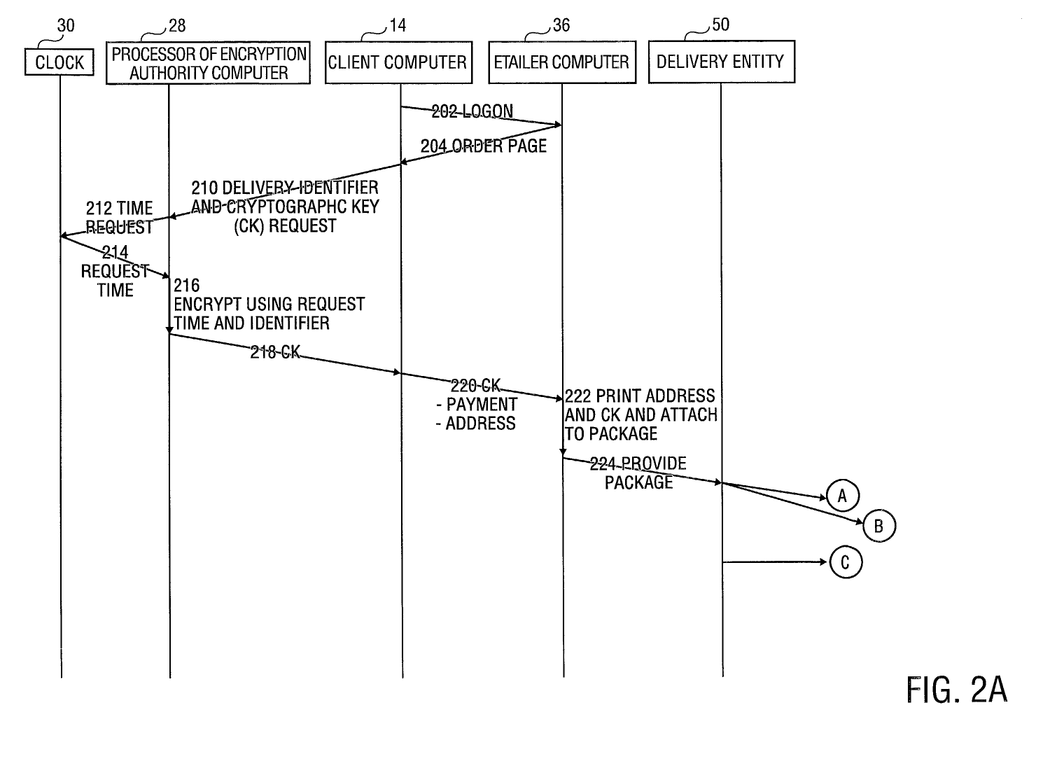

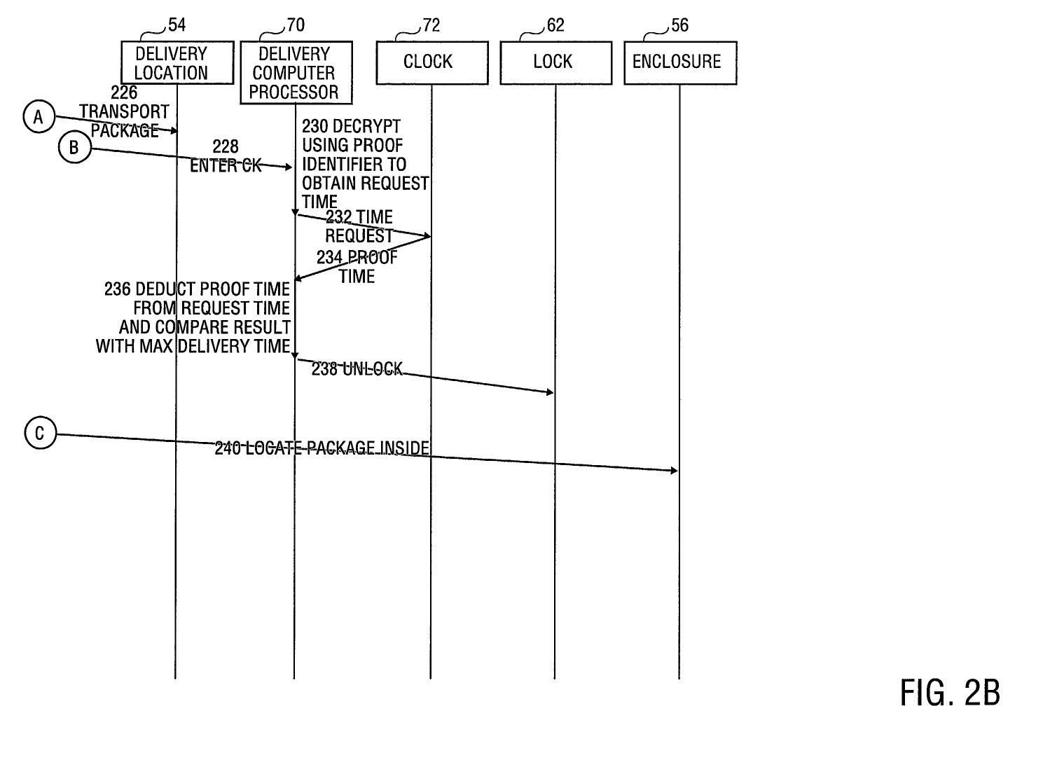

FIG. 2 illustrates a method for using the system illustrated in FIG. 1. The components of the system reproduced in FIG. 2 include the clock 30, the processor 28 of the encryption authority computer 16, one client computer 14, the etailer computer 36, the delivery entity 50, one delivery location 54, and the delivery computer processor 70, the clock 72, the lock 62, and the enclosure 56 at the specific delivery location 54. The method of FIG. 2 will now be described in conjunction with the system of FIG. 1.

The intention is for a client at one of the client computers 14 to have a package delivered in an enclosure 56 at a selected one of the locations 54. The client computer 14 is usually located within the selected location 54. For purposes of our discussion, we assume that the client computer 14 indicated as client computer 3 is located in the location 54 indicated as location 2 with address 2.

In step 202, a client utilizes the client computer 14 to log onto the etailer computer 36. The etailer computer 36 may have stored thereon a database of articles that can be purchased for different prices. The client can search the database and select a specific article which the client wishes to purchase. Once an article is selected which the client wishes to purchase, the etailer computer 36 generates the order page 42. The order page 42 includes the item selected by the client, indicated as the delivery package, and the price of the delivery package including shipping charges. The order page also includes payment entry space where the client can enter credit card information to which the purchase price can be billed. The order page also includes space for entry of an address. The order page further includes space for entry of a cryptographic key. The order page also includes an order button which, when clicked on, signifies an acceptance of the purchase.

In step 204, the etailer computer 36 transmits the order page 42 to the client computer 14. The order page 42 is viewed on a monitor of the client computer 14.

Steps 202 and 204 are both executed by the client using a first browser on the client computer 14. The client may then open a second browser on the client computer 14 to execute steps 210, 212, 214, 216, and 218. The second browser is then closed, whereafter steps 220 and the following steps are again executed utilizing the first browser.

In step 210, after opening of the second browser, the client utilizes the second browser to transmit the delivery identifier 26 (delivery identifier 3) stored on the client computer 14 (client computer 3) together with a cryptographic key request to the processor 28 of the encryption authority computer 16. As mentioned earlier, the delivery identifier 26 is unique to the specific client computer 14. As also previously mentioned, the specific client 14 is located at a specific location 54. The delivery identifier (delivery identifier 3) transmitted in 210 is thus associated with a specific location 54 (location 2).

In step 212, the processor 28 of the encryption authority computer 16 transmits a time request signal to the clock 30. In step 214, the clock 30 transmits a request time 214 to the processor 28 of the encryption authority computer 16.

The processor 28 of the encryption authority computer 16 then invokes the encryption code 32. The encryption code utilizes the delivery identifier transmitted in step 210 as a key to encrypt the request time transmitted in step 214 to generate a cryptographic key. An encryption code of this kind is known in the art.

In step 218, the processor 28 of the encryption authority computer 16 transmits the cryptographic key back to the client computer 14. The client at the client computer 14 then has access to the cryptographic key. The client at the client computer 14 then closes the second browser and enters the cryptographic key into the cryptographic key space provided on the order page transmitted in step 208. The client enters a credit card number, an expiration date of the credit card, and an address for purpose of delivery. The address is the address of the location 54 indicated by location 2 with address 2 in FIG. 1.

In step 220, the client then order page, including the information entered thereon, back to the etailer computer 36.

The etailer computer 36 may then be used to obtain payment for the article purchased by transmitting the credit card and payment information to a credit card authority. The credit card authority then deducts an amount from the account indicated by the credit card information and transfers the amount to an account indicated by the etailer 18.

In step 222, the etailer computer 36 transmits the address and the cryptographic key to the printer 38. A label is printed by the printer 38, the label including the address and the cryptographic key. A person employed by the etailer 38 removes the label from the printer 38 and attaches the label to one delivery package 40 corresponding to the article purchased, step 206. The label is attached in the space located on the delivery package 40 designated for the address space and cryptographic key space. The delivery package 40 ordered by the client now has an address to which the client wishes the package 40 to be delivered, as well as a cryptographic key thereon which is generated utilizing the delivery identifier 26 and a request time provided by the clock 30.

In step 224, the delivery package 40 is provided to the delivery entity 50. The delivery entity 50 may for example pick the delivery package 40 up at a warehouse where the etailer 18 stores the delivery package 40 and other packages.

In step 226, the delivery entity 50 transports the delivery package 40 to its designated location. The delivery entity utilizes the address located on the delivery package 40 to seek and locate the location 54 indicated as location 2 with address 2.

A delivery person employed with the delivery entity 50 may then remove the delivery package 40 from a vehicle used to transport the delivery package 40, and transport the delivery package 40 by hand to the enclosure 56 located at the location 54. A delivery person transporting the package to the enclosure 56 will then find the closure member 60 located in its closed position wherein the lock 62 engages with the closure member 60 so that access cannot be obtained to the internal volume of the enclosure 56.

In step 228, the delivery person enters the cryptographic key into the data entry device 66. The data entry device 66 is a keypad having characters such as numerals thereon. The cryptographic key includes a plurality of numerals located one after the other. The delivery person reads the cryptographic key from the delivery package 40 and types the cryptographic key onto the keypad. When the cryptographic key is typed into the keypad, the keypad forwards the cryptographic key to the processor 70. The cryptographic key is then stored in cache memory of the processor 70.

In step 230, the cryptographic key is decrypted. This is initiated by the delivery person who hits enter on the keypad. An entry command is transmitted from the keypad to the processor 70 which invokes the decryption code 80. The decryption code 80 utilizes the proof identifier 3 to decrypt the cryptographic key and obtain the request time transmitted in step 214. If the proof identifier 76 is the same as the delivery identifier 26, the request time produced by the decryption code 80 is the same as the request time transmitted in step 214. A mismatch between the proof identifier 76 and the delivery identifier 26 will render a value that is substantially different from the request time 214.

In step 232, the processor 70 transmits a time request to the clock 72. In step 234, the clock 72 transmits a proof time back to the processor 70. The clock 72 is synchronized with the clock 30 so that a difference between a value of the proof time transmitted in step 234 and a value of the request time transmitted in step 214 equals an amount of time which, in a real sense, lapsed between the execution of step 214 and step 234.

In step 236, a comparitor within the processor 70 deducts the proof time provided in step 234 from the request time provided in step 230 to obtain an actual delivery time, i.e. the time actually taken from when step 214 is executed until step 234 is executed (provided the proof identifier 76 matches the delivery identifier 26).

The processor 70 then compares the actual delivery time with the maximum delivery time 78 stored in the memory 74. A positive result is obtained if the actual delivery time is less than the maximum delivery time 78. For example, the maximum delivery time 78 may be set at ten days. A positive result is obtained if the actual delivery time is seven days and a negative result is obtained if the actual delivery time is eleven days. A positive result will also only be obtained if the delivery identifier 26 matches the proof identifier 76 and a negative result will always be obtained if there is a mismatch between the delivery identifier 26 and the proof identifier.

In step 238, the processor provides a signal to the lock 62 which is responsive to the signal to disengage the closure member 60 so that the closure member can be moved out of its closed position. The signal is only transmitted from the processor 70 to the lock 62 if a positive result is obtained in step 236. The proof identifier 76 differs from proof identifiers of other computers at other ones of the enclosures 56. The lock will therefore only be opened if delivery is made to the correct location.

It can thus be seen that the closure member 60 will only be allowed to open upon the following conditions:

(i) the delivery identifier 26 matches the proof identifier 76 which will only occur if the delivery package 40 s delivered to the enclosure 56 at the location 54 with the address at which the client computer 14 is located; and

(ii) the time lapsed from step 214 to step 234 is less than the maximum delivery time 78.

It can thus be seen that the criteria upon which the enclosure 56 is opened will ensure that:

(i) the enclosure 56 cannot be opened unless a delivery personnel has a cryptographic key which inherently identifies the specific enclosure 56 with the specific client computer 14 by virtue of comparing the delivery identifier 26 with a proof identifier 76; and

(ii) the delivery package 40 is delivered within a selected maximum delivery time.

Once the lock 62 is disengaged from the closure member 60, the delivery person moves the closure member from its closed position to its open position. The delivery person then executes step 240 wherein the delivery person locates the package in the internal volume of the enclosure 56. The delivery person then moves the closure member from its open position into its closed position, whereafter the lock 62 automatically engages with the closure member 60 to engage the closure member 60 in its closed position.

It can then thus be seen from the aforegoing description that delivery package can be delivered to an enclosure in a secure manner wherein the enclosure can only be opened utilizing a cryptographic key having a specific delivery identifier, known only to the client, and a specific request time inherent therein.

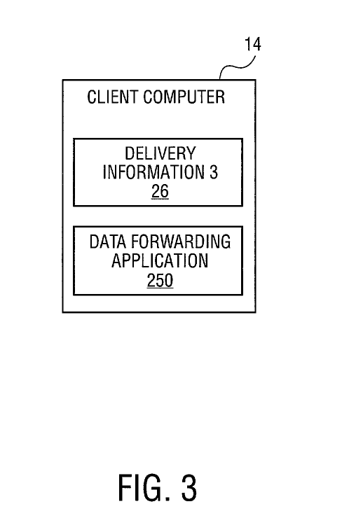

FIG. 3 illustrates one of the client computers 14, which in addition to the delivery identifier 26, also includes a data forwarding the application 250. The data forwarding application 250 allows for automation of steps 210 and 220 in FIG. 2. In particular, the etailer computer 36 in step 208 transmits a cryptographic key request (as opposed to a cryptographic key request page) to the client computer 14. The client computer then, in step 210 automatically, upon receipt of the cryptographic key request, transmits the delivery identifier and the cryptographic key request to the processor 28 of the encryption authority computer 16. Steps 212, 214, and 216 are then executed as previously described. In step 218, the processor 28 of the encryption authority computer 16 transmits the cryptographic key to the client computer 14. In step 220, the client computer 14 automatically forwards the cryptographic key to the etailer computer 36. There is no need for the cryptographic key to be displayed on a browser at the client computer 14. There is also no need for the client at the client computer 14 to open a second browser. Steps 208, 210, 212, 214, 216, 218, and 220 are executed entirely without interaction, or even knowledge, of a client at the client computer 14.

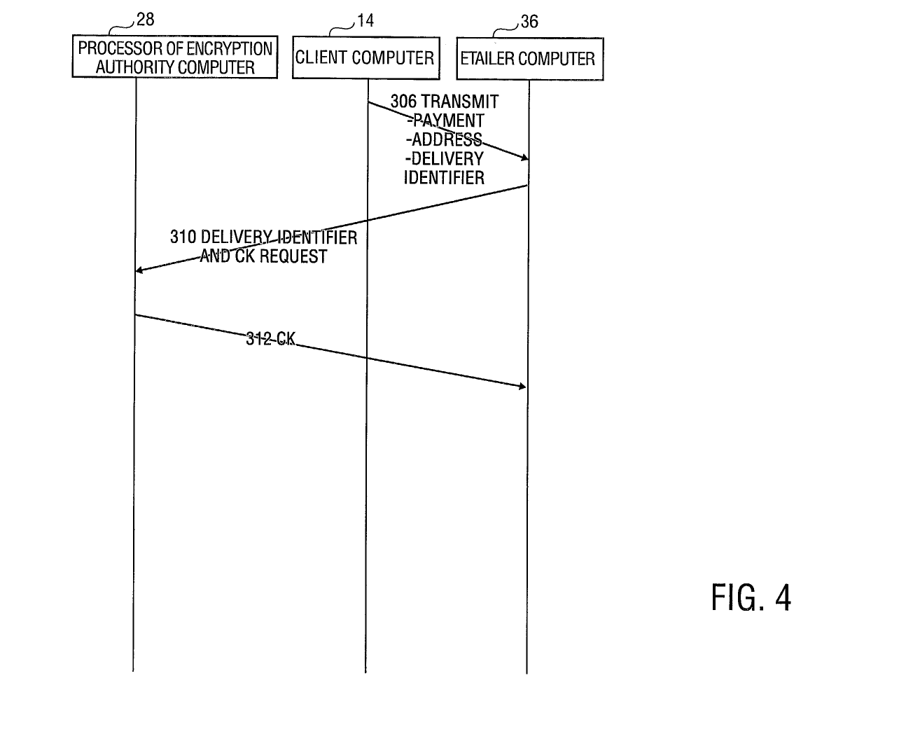

FIG. 4 illustrates another method in which the system may operate, wherein the client computer 14 is bypassed. Instead of step 206, wherein the client computer 14 is utilized to transmit any of the payment information and address information, step 306 is executed wherein the client computer 14 is used to transmit the payment information, the address information, as well as the delivery identifier 26. The etailer computer 36 now has the additional information of the delivery identifier. In step 310, the etailer computer 36 transmits the delivery identifier and a cryptographic key request directly to the processor 28 of the encryption authority computer 16, thus bypassing the client computer 14. Steps 212, 214, and 216 are then executed out as described with reference to FIG. 2. Following step 216, step 310 is executed wherein the encryption authority computer 28 transmits the cryptographic key directly to the etailer computer 36, thus again bypassing the client computer 14.

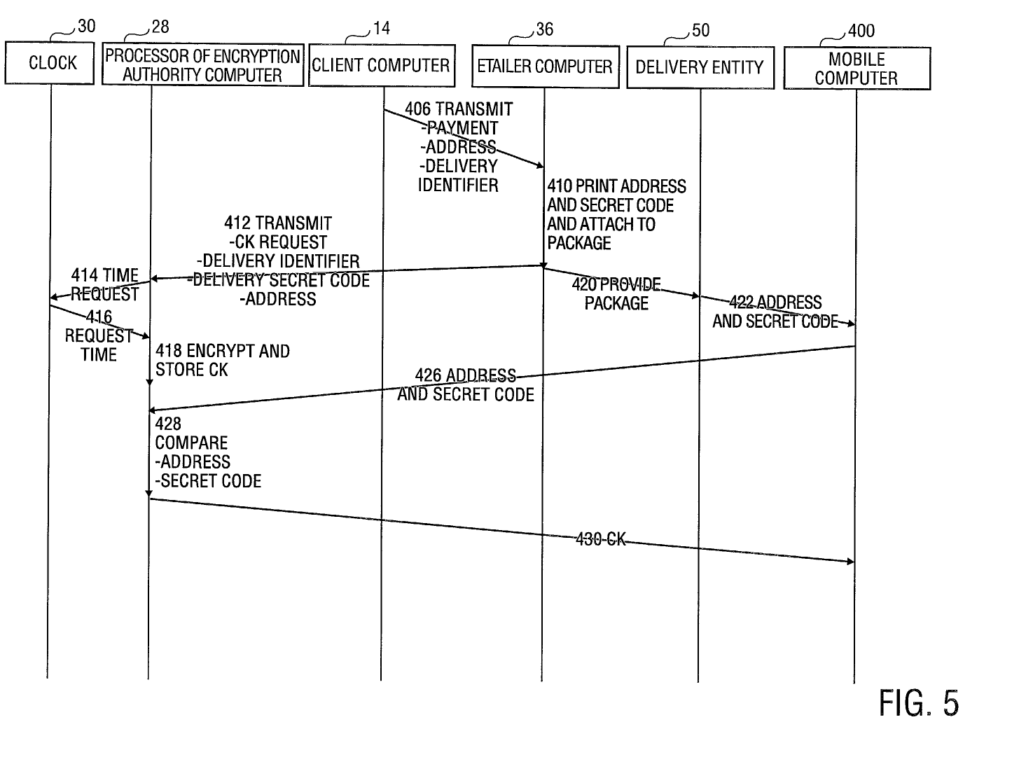

FIG. 5 illustrates another method in which the system can be used for securely delivering the package. Step 406 is the same as step 306 in FIG. 4. Step 410 is then executed wherein the etailer computer 36 selects a secret code which differs from package to package. The etailer computer 36 prints the address, provided in step 406, and the secret code on a label, whereafter the label is attached to the delivery package. Step 412 is also executed by the etailer computer 36, wherein the etailer computer 36 transmits a cryptographic key request, the delivery identifier, provided in step 406, the delivery secret code, selected in step 410, and the address, provided in step 406, to the processor 28 of the encryption authority computer 16. Steps 414 and 416 are the same as steps 212 and 214 in FIG. 2, respectively. Following step 416, the processor 28 executes step 418, wherein the request time provided in step 416 is encrypted utilizing the delivery identifier provided in step 412 as a key to render a cryptographic key. The cryptographic key is then stored in memory of the encryption authority computer.

Following step 410, the etailer executes step 420, wherein the etailer provides the package to the delivery entity 50. The delivery entity 50 then transports the package to the delivery location (step 226 in FIG. 2).

A delivery person employed by a delivery entity 50 carries a mobile computer 400 having a keypad thereon. The mobile computer 400 is wirelessly connected to the network 12. When the delivery person reaches the location where delivery is to be made, the delivery person executes step 422. In step 422, the delivery person enters the address and the secret code, obtained from the label on the package, onto the keypad of the mobile computer 400. The mobile computer 400, in step 426, transmits the address and secret code wirelessly to the processor 28 of the encryption authority computer. The processor 28 of the encryption authority computer then executes step 428. In step 428, the processor 28 compares the address received from the mobile computer 400 with the address transmitted in step 412 and compares the secret code transmitted from the mobile computer 400 with the secret code transmitted in step 412. Should the addresses match and the secret codes match, the processor 28 of the encryption authority computer then executes step 430. In step 430, the cryptographic key is transmitted from the processor 28 back to the mobile computer 400. The delivery person then has access to the cryptographic key. The delivery person then executes step 228 of FIG. 2, whereafter the following steps of FIG. 2 are executed until the delivery package is securely located inside the enclosure.

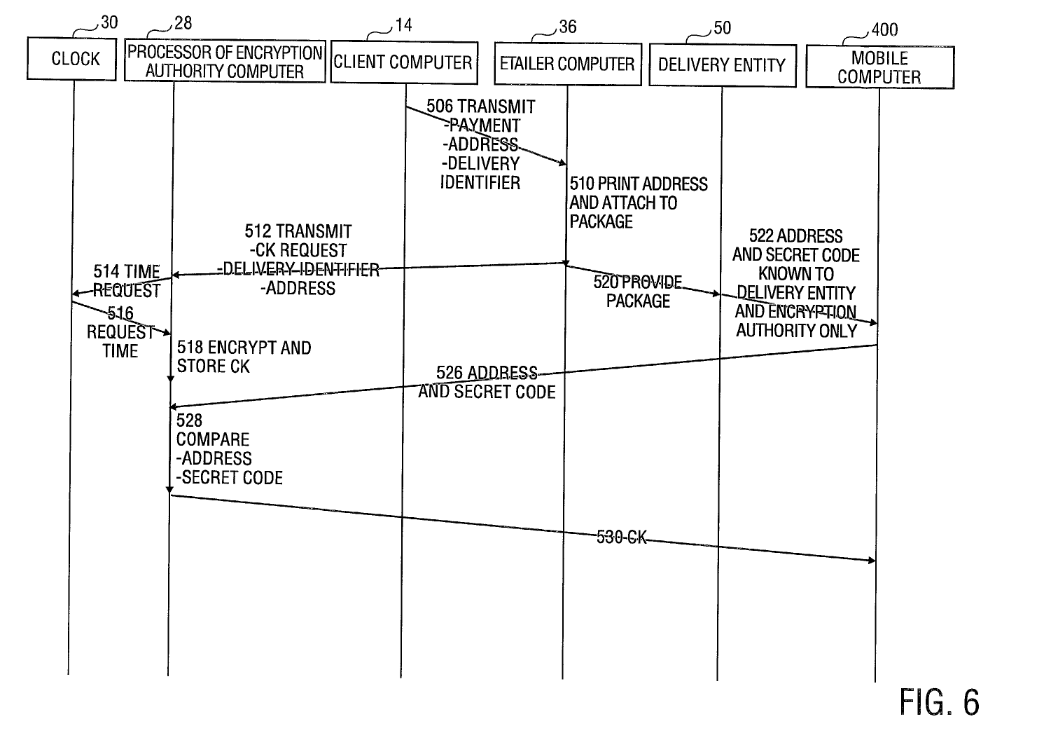

FIG. 6 illustrates another method in which the system can be used. The method illustrated in FIG. 6 is similar to the method in FIG. 5 except that a secret code is used that is known to the encryption authority and a delivery person, and not a secret code known to an etailer. Step 506 is the same as step 406. In step 510 the etailer does not attach a secret code and the etailer does not transmit a secret code in step 512. Steps 510 and 512 are the same as steps 414, 416, 418, and 420 respectively. In step 522, the delivery person types in the address from the package. The delivery person also types a secret code known only to the delivery entity (and the delivery person) and the encryption authority. The secret code is a code that is pre-arranged to identify the delivery person to the encryption authority. In step 526 the address and the secret code are transmitted to the processor 28 of the encryption authority computer. In step 528, the processor 28 compares the transmitted secret code with a proof code and the address to the address transmitted in step 512 and generates and transmits a cryptographic key in step 530 upon a favorable comparison.

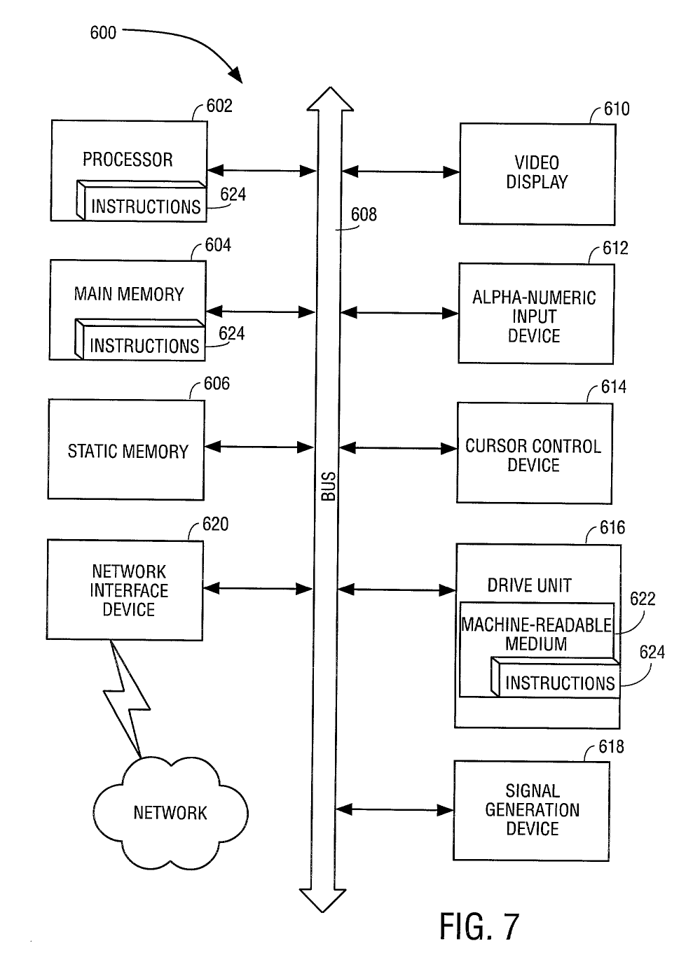

FIG. 7 illustrates the computer 600 of the computers in FIG. 1 in more detail. The computer 600 includes a processor 602, a main memory 604 and a static memory 606 which communicate with each other by a bus 608. The computer 600 is further shown to include a video display unit 610 e.g. a liquid crystal display (LCD). The computer 600 also includes an alpha-numeric input device 612 (e.g. a keyboard), a cursor control device 614 (e.g. a mouse), a disk drive unit 616, a signal generation device 618 (e.g. a speaker), and a network interface device 620. Once a program 170 is loaded into the computer, software 624 resides, completely or at least partially, within the main memory 604 and/or within the processor 602. Some of the software also remains on a disk drive.

In the examples hereinbefore described a client computer 14 located at a location 54 is connected through a network 12 and the client computer 14 is used for purposes of shopping. It should be understood that a client may utilize other means for shopping. The client may for example browse a catalog and obtain a telephone number from the catalog or obtain a telephone number from an infomercial on television. The client may then utilize a telephone to order a product. Alternatively, a mobile device such as a handheld computer or a mobile telephone may wirelessly connect to a network and be used for browsing and ordering goods.

Examples are also given of a client who browses a database of an etailer 18 utilizing a client computer 14, and entering data on a order page 42. A client may alternatively use a telephone to access a directory of goods and order goods via the telephone.

Request for a cryptographic key is executed over a computer network. As an alternative, a client or etailer may request a cryptographic key by dialing a telephone number and so gain access to a telephonic key request service which can process a cryptographic key request and return a cryptographic key telephonically.

The data entry device 66 is a keypad, as described in the example. It should however be understood that other data entry devices may be used such as smart cards, or wireless devices utilizing for example radio frequency or infrared transmission.

It is also possible to have a code entered into a computer at an enclosure from a remote location miles away from the enclosure. A wireless network such as a pager or cellular phone network may be used for such a purpose. It is also possible to have the code be transmitted via a home network of a house where the enclosure is located.

Entry of a cryptographic key may also be executed automatically. For example, in the examples provided in FIGS. 5 and 6, a delivery person receives a code in a mobile computer 400, reads the code from the mobile computer and then enters the code manually. The mobile computer 400 may be programmed so that, as soon as the cryptographic key is received in step 430 or 530, the cryptographic key is automatically transmitted via radio frequency transmission, and received by a radio frequency receiver connected to the computer 64 which controls the lock 62.

In the examples given above, the enclosure 56 is an enclosure located in front of a building of a location 54. The enclosure 56 may take any other form such as a garage, a closet, a shed, or a trunk of a car. It is also possible that the enclosure 56 may be built into a wall of a home and have the closure member 60 open to an outside of the home and another closure member opening to the inside of the home. The closure member located on the inside of the home may have a conventional lock that can be opened in a conventional manner with a key.

The enclosures 56 may also form a cluster of enclosures. Such a cluster of enclosures may be of the kind often provided by postal services wherein the enclosures are located on top of one another in columns, the columns being located adjacent one another. An array of enclosures is so created wherein each enclosure is at its own location in the array.

The invention is also been described with reference to allowing a delivery person to open the enclosure. It is also possible to utilize the invention for restricting a person from or allowing the person to remove a package from an enclosure.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of delivering a package comprising:
associating an address with a delivery package, the address identifying a specific physical location and differing from addresses of other locations;
handing the delivery package to a delivery entity, the delivery entity utilizing the address associated with the delivery package to seek and find the specific physical location identified by the address;
providing a delivery identifier to a processor of a cryptographic authority computer, the delivery identifier identifying a specific enclosure at the specific physical location and differing from delivery identifiers of delivery enclosures at other locations;
providing a request time to the processor of a cryptographic authority computer, the processor of a cryptographic authority computer generating a cryptographic key utilizing the delivery identifier and the request time; and
providing the cryptographic key to the delivery entity, the delivery entity entering the cryptographic key into a processor of a delivery computer, the delivery computer decrypting the cryptographic key and causing for a lock on the delivery enclosures to be unlocked if the delivery identifier matches a proof identifier located in the delivery computer and a difference in time between a proof time, from a clock providing the proof time to the processor of the delivery computer, and the request time is less than a selected maximum, unlocking of the lock allowing the delivery entity to open a closure member of the enclosure to gain access to an internal volume of the enclosure, the delivery entity locating the delivery package in the internal volume.

2. The method of claim 1 further comprising:
locating the cryptographic key on the delivery package.

3. The method of claim 2 further comprising:
utilizing a client computer to access an order page located on an etailer computer;
utilizing the client computer to order the delivery package, identifying the address of the specific physical location and offering payment of an agreed upon purchase price of the delivery package; and
providing the cryptographic key to the etailer computer who ensures that the cryptographic key is located on the delivery package.

4. The method of claim 3 wherein the client computer is utilized to provide the cryptographic key to the etailer computer.

5. The method of claim 4 further comprising:
utilizing the etailer computer to transmit a first cryptographic key request to the client computer;
utilizing the client computer to provide a second cryptographic key request to the processor of cryptographic authority computer;
utilizing the cryptographic authority computer to transmit the cryptographic key to the client computer; and
utilizing the client computer to transmit the cryptographic key to the etailer computer.

6. The method of claim 5 wherein a client operates the client computer to transmit the second cryptographic key request to the cryptographic authority computer.

7. The method of claim 6 wherein the client operates the client computer to transmit the cryptographic key to the etailer computer.

8. The method of claim 1 wherein the processor of the cryptographic authority computer receives the request time from a clock of the cryptographic authority computer.

9. The method of claim 1 wherein the delivery computer includes a keypad and an employee of the delivery entity enters the cryptographic key on the keypad.

10. The method of claim 1 wherein the processor of the cryptographic authority computer encrypts the request time by utilizing the delivery identifier as a key and wherein the processor of the delivery computer decrypts the cryptographic key utilizing the proof identifier to obtain the request time.

11. The method of claim 5 wherein the client computer transmits the cryptographic key request to the cryptographic authority computer automatically upon receiving the cryptographic key request from the etailer computer.

12. The method of claim 11 wherein the client computer transmits the cryptographic key to the etailer computer automatically upon receiving of the cryptographic key from the cryptographic authority computer.

13. The method of claim 2 further comprising:
utilizing the etailer computer to transmit a cryptographic key request to a cryptographic authority computer by bypassing the client computer; and
utilizing the cryptographic authority computer to transmit the cryptographic key to the etailer computer by bypassing the client computer.

14. The method of claim 1 further comprising:
utilizing a mobile computer of the delivery entity to transmit a cryptographic key request to a cryptographic authority computer; and
utilizing the cryptographic authority computer to transmit the cryptographic key to the mobile computer.

15. The method of claim 14 wherein the cryptographic key request is wirelessly transmitted by the mobile computer.

16. A method of delivering a package comprising:
providing a delivery identifier to a processor of a cryptographic authority computer, the delivery identifier identifying a specific enclosure at a specific physical location and differing from delivery enclosures at other locations;
providing a request time to the processor of a cryptographic authority computer, the processor of a cryptographic authority computer generating a cryptographic key utilizing the delivery identifier and the request time;
locating the cryptographic key on a delivery package; and
providing the package to a delivery entity, the delivery entity transporting the package to a delivery location and entering the cryptographic key into a processor of a delivery computer at the delivery location, the delivery computer decrypting the cryptographic key and causing for a lock on the delivery enclosures to be unlocked if the delivery identifier matches a proof identifier located in the delivery computer and a difference in time between a proof time from a clock at the delivery entity and the request time is less than a selected maximum, unlocking of the lock allowing the delivery entity to open a closure member of the enclosure to gain access to an internal volume of the enclosure, the delivery entity locating the delivery package in the internal volume.

17. A method of delivering a package comprising:
transmitting a delivery identifier from one computer to a processor of a cryptographic authority computer, the delivery identifier identifying a specific enclosure at a specific physical location and differing from delivery enclosures at other locations;
providing a request time to the processor of a cryptographic authority computer, the processor of a cryptographic authority computer generating a cryptographic key utilizing the delivery identifier and the request time; and
providing the package to a delivery person, the delivery person transporting the package to a delivery location and causing the cryptographic key to be entered into a processor of a delivery computer at the delivery location, the delivery computer decrypting the cryptographic key and causing for a lock on the delivery enclosure to be unlocked if the delivery identifier matches a proof identifier located in the delivery computer and a difference in time between a proof time from a clock at the delivery entity and the request time is less than a selected maximum, unlocking of the lock allowing a person to open a closure member of the enclosure to gain access to an internal volume of the enclosure, the delivery person locating the delivery package in the internal volume.

18. The method of claim 17 wherein the person allowed to open the closure member is the delivery person.
